(19) United States
(12) Patent Application Publication
(10) Pub. No.: US 2021/0019706 A1
(43) Pub. Date: Jan. 21, 2021

(54) ORGANIZATION FRAMEWORK FOR NON-FUNCTIONAL REQUIREMENTS

(71) Applicant: 1230604 BC Ltd., Toronto (CA)

(72) Inventors: Nischal BHALLA, Mississauga (CA); Rohit Kumar SETHI, Toronto (CA); Ramanan SIVARANJAN, Toronto (CA); Ehsan FOROUGHI, Toronto (CA); Geoffrey Charles WHITTINGTON, Waterloo (CA); Leta MONTOPOLI, Toronto (CA); Emin THAM, Surrey (CA); Hanif VIRANI, Toronto (CA)

(21) Appl. No.: 16/931,646

(22) Filed: Jul. 17, 2020

Related U.S. Application Data
(60) Provisional application No. 62/875,591, filed on Jul. 18, 2019.

(51) Int. Cl. G06Q 10/10; G06Q 10/06

(52) U.S. Cl. CPC G06Q 10/103; G06Q 10/06315; G06Q 10/06313

(57) ABSTRACT

An organization framework system and method for compliance with non-functional requirements is described. The system has a regulatory standards database with a plurality of regulatory standards, each regulatory standard comprising a set of regulatory non-functional requirements, an organization standards database with a plurality of organization standards, each organization standard comprising a set of organization non-functional requirements, and an organization framework comprising a master set of regulatory non-functional requirements and organization non-functional requirements.

### CROSS-REFERENCE TO RELATED APPLICATIONS

This application claims priority to U.S. provisional patent application U.S.62/875,591 filed 18 Jul. 2019, which is hereby incorporated by reference herein in its entirety.

### FIELD OF THE INVENTION

The present invention pertains to a framework system and method for establishing and maintaining a central repository of non-functional requirements for an organization. In particular, the present system and method is capable of handling a library of compliance non-functional requirements based on regulatory standards and a library of organization non-functional requirements based on organization policies for standardization of operation and customization within an organization throughout the lifecycle of project development and maintenance in the organization.

### BACKGROUND

Project management in an organization can be very complex when a multitude of functional and non-functional requirements must be met to complete the project. When building software applications, developers address both functional considerations, such as the core functions of the system, as well as non-functional concerns such as security, regulatory compliance, operability, and accessibility. Requirements for a software application are usually defined during the requirements or development phase of the software application, and the requirements include both functional and non-functional requirements of the software application. In this era of globalization and modern software systems, non-functional requirements and regulatory compliance requirements must be a significant consideration during the development of software applications to ensure compliance with jurisdictional, security, and legal standards. In non-software projects, similar complications arise, with a multitude of legal, organization, and regulatory requirements that are often complex and jurisdictional in nature. Ensuring that all compliance requirements are satisfied is critical, and itemizing and tracking completion of non-functional requirements can be a challenging task. Further, each individual organization has its own organizational requirements which comprise the specifications of the goals of a business, the standards imposed by the business to all products, and the desired quality for the project. When considered together, the set of requirements for each project can become onerous and challenging for project managers to keep track of and ensure compliance to, and can put a strain on managers to ensure that all requirements have been complied with.

Compliance with the multitude of non-functional requirements (in addition to the functional requirements) within all of the projects in an organization can result in complexity in development, maintenance, porting, and scalability to required volumes. With regard to organizational customization, if the organizational quality and customization requirements of the project are not set out clearly during development, particularly before the design phase and development phase of the project, it can become difficult to ensure that the final product that is being created, designed, and developed will meet such requirements. Many software products are found to lack certain quality requirements either at the time of testing or during operation in the production environment which can require re-designing and/or modification to the software code, followed by re-testing, which is an iterative, time consuming and resource intensive process. For example, the software product may meet its functional requirements but may need to be redesigned due to lack of compliance to non-functional requirements, whether those non-functional requirements are part of a regulatory standard, organizational standard, or both. In international logistics projects, the failure to, for example, timely obtain an appropriate import or export permission can result in significant delays and loss of revenue.

The ability to fully address non-functional requirements requires particular knowledge from different regulatory domains and an understanding of the composition and interdependencies between non-functional requirements. This can require a multitude of different developers, designers, and technical specialists working on the same project to ensure that all of the non-functional requirements for the project are met. Additionally, individual non-functional requirements require regular updating to ensure up-to-date compliance with regulatory standards and organizational policies, and maintaining a single centralized and up-to-date system comprising all of the requirements of an organization can be cumbersome and challenging to disseminate to ensure compliance of all projects within an organization, and at all phases in the project lifecycle.

U.S. Pat. No. 10,095,478 to Ghaisas et al. describes a computer implemented system and method for identifying project requirements which identifies and classifies architecturally significant functional requirements and generates a meta schema related to architecturally significant functional requirements based on the classification of architecturally significant functional requirements and pre-defined schema.

There remains a need for an organization framework of non-functional requirements for establishing and maintaining a central repository of non-functional requirements for an organization throughout the lifecycle of projects and software applications in the organization.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a framework system and method for establishing and maintaining a central repository of non-functional requirements for an organization. In particular, the present system and method is capable of handling a library of compliance non-functional requirements and regulatory non-functional requirements for standardization of operation and customization within an organization throughout the lifecycle of software and non-software applications and projects in the organization.

In an aspect there is provided a method for generating an organization framework of non-functional requirements, the method comprising: storing an electronic library of organization non-functional requirements, each organization non-functional requirement comprising a plurality of content elements and derived from at least one organization policy;

storing an electronic library of compliance non-functional requirements, each compliance non-functional requirement comprising a plurality of content elements and derived from at least one regulatory standard, the regulatory standard applicable to at least one project in the organization; applying an operational content pack to combine relevant non-functional requirements from the library of organization non-functional requirements and the library of compliance non-functional requirements into a single organization framework comprising a master set of non-functional requirements for the organization; selecting a subset of non-functional requirements from the master set of non-functional requirements for one or more project framework, the subset of non-functional requirements pertinent to a particular project in the organization; and providing the subset of non-functional requirements as a prioritized task list for completing the project.

In another aspect there is provided a method for generating an organization framework of non-functional requirements, the method comprising: assembling a library of organization non-functional requirements, each organization non-functional requirement derived from at least one organization policy, the organization policy pertaining to the operation of an organization; assembling a library of compliance non-functional requirements, each compliance non-functional requirement derived from at least one regulatory standard, the regulatory standard; and compiling the library of organization non-functional requirements and library of compliance non-functional requirements to create a master set of non-functional requirements for the organization to generate an organizational framework.

In an embodiment, the method further comprises customizing at least one compliance non-functional requirement.

In another embodiment, the method further comprises customizing at least one non-functional requirement and storing the customization as a content pack comprising a set of content element modifications to the at least one non-functional requirement.

In another embodiment, the method further comprises expressing the master set of non-functional requirements as a content pack comprising metadata and a set of transformations of the content elements in the library of organization non-functional requirements and the library of compliance non-functional requirements.

In another embodiment, the electronic library of compliance non-functional requirements is an external content library.

In another embodiment, the method further comprises applying more than one operational content pack to combine relevant non-functional requirements from the library of organization non-functional requirements and the library of compliance non-functional requirements.

In another embodiment, the method further comprises customizing at least one organization non-functional requirement.

In another embodiment, the library of compliance non-functional requirements comprises one or more content packs, each content pack comprising a set of compliance non-functional requirements pertinent to a specific regulatory domain.

In another embodiment, the specific regulatory domain is selected from health, insurance, education, security, accounting, law, importation, exportation, jurisdictional laws, professional requirements, banking, software development, software security, privacy, and pharmaceutical compliance.

In another embodiment, the library of compliance non-functional requirements is comprised of one or more content packs, each content pack comprising a plurality of compliance non-functional requirements relating to a specific regulatory standard.

In another embodiment, the organization framework is applied to a project framework.

In another embodiment, the method further comprises updating at least one organization non-functional requirement and pushing the updated organization non-functional requirement to one or more project framework.

In another embodiment, the method further comprises updating at least one compliance non-functional requirement and pushing the updated compliance non-functional requirement to one or more project framework.

In another embodiment, updating the at least one compliance non-functional requirement is based on a change in the regulatory standard, security update, or law.

In another embodiment, the regulatory standard is all or part of a legal standard, security standard, financial standard, federal law, provincial law, state law, municipal law, regulatory body standard, accounting standard, or combination thereof.

In another embodiment, the method further comprises selecting a subset of compliance non-functional requirements from the organization framework to apply to a project framework.

In another embodiment, the method further comprises generating an audit report on organization compliance with at least one regulatory standard.

In another embodiment, the subset of non-functional requirements in the project framework satisfies all of the compliance and organization non-functional requirements of the project

In another aspect there is provided an organization framework system comprising: a content library of compliance requirements comprising a plurality of compliance non-functional requirements, each compliance non-functional requirement comprising a plurality of content elements, and derived from at least one regulatory standard; a content library of organization policies comprising a plurality of organization non-functional requirements, each organization non-functional requirement comprising a plurality of content elements, and derived from at least one organization policy; an operational content pack comprising instructions for combining relevant non-functional requirements from the library of organization non-functional requirements and selected non-functional requirements from the library of compliance non-functional requirements; an organization framework comprising a master set of non-functional requirements for the organization based on the combining instructions of the operational content pack; and a project framework comprising a subset of non-functional requirements pertinent to a particular project in the organization, wherein the subset of non-functional requirements satisfies the compliance and organization non-functional requirements of the project.

In another aspect there is provided an organization framework system comprising: a library of compliance requirements comprising a plurality of compliance non-functional requirements, each compliance non-functional requirement derived from at least one regulatory standard; and a library of organization policies comprising a plurality of organization non-functional requirements each organization non-functional requirement derived from at least one organization policy.

In an embodiment of the system, at least one of the plurality of compliance non-functional requirements is customized.

In another embodiment, the system further comprises at least one project framework specific to a project, wherein the project framework is a subset of the organization framework.

In an embodiment of the system, at least one of the plurality of compliance non-functional requirements comprises a compliance requirement and at least one compliance constraint.

In another aspect there is provided a computing device comprising a processor and a memory coupled to the processor, wherein the processor is configured to execute programmed instructions stored in the memory to: store an electronic library of organization non-functional requirements, each organization non-functional requirement comprising a plurality of content elements and derived from at least one organization policy; store an electronic library of compliance non-functional requirements, each compliance non-functional requirement comprising a plurality of content elements and derived from at least one regulatory standard, the regulatory standard applicable to at least one project in the organization; apply an operational content pack to combine relevant non-functional requirements from the library of organization non-functional requirements and the library of compliance non-functional requirements into a single organization framework comprising a master set of non-functional requirements for the organization; select a subset of non-functional requirements from the master set of non-functional requirements for one or more project framework, the subset of non-functional requirements pertinent to a particular project in the organization; and provide the subset of non-functional requirements as a prioritized task list for completing the project.

In another aspect there is provided a non-transitory computer-readable storage medium having one or more instructions thereon for identifying software application vulnerabilities during a software lifecycle, the instructions when executed by a processor causing the processor to: store an electronic library of organization non-functional requirements, each organization non-functional requirement comprising a plurality of content elements and derived from at least one organization policy; store an electronic library of compliance non-functional requirements, each compliance non-functional requirement comprising a plurality of content elements and derived from at least one regulatory standard, the regulatory standard applicable to at least one project in the organization; apply an operational content pack to combine relevant non-functional requirements from the library of organization non-functional requirements and the library of compliance non-functional requirements into a single organization framework comprising a master set of non-functional requirements for the organization; select a subset of non-functional requirements from the master set of non-functional requirements for one or more project framework, the subset of non-functional requirements pertinent to a particular project in the organization; and provide the subset of non-functional requirements as a prioritized task list for completing the project.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 is a flowchart depicting an organization framework for an organization;

FIG. 2 is a system overview of an organization framework for an organization;

FIG. 3 is an entry for a non-functional requirement having a plurality of content elements;

FIG. 4 illustrates the policy to execution gap in project compliance;

FIG. 5 is a flowchart depicting a method of generating an audit or compliance report for a regulatory standard; and

FIG. 6 is a representation of graphical user interface with prioritized task list of project tasks in a project framework.

### DETAILED DESCRIPTION OF THE INVENTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

The term “non-functional requirement” (NFR) as used herein refers to a requirement that specifies criteria used to judge the operation of a system, rather than specific behaviors in or of the system (which are generally referred to as functional requirements). Non-functional requirements define how a system is supposed to be, and are generally in the form of “the system shall be <requirement>”, wherein the requirement is an overall property of the system as a whole or of a particular aspect and not a specific function. Non-functional requirements referred to herein are stored as a plurality of electronic content elements in a content element library.

The term “Organization Framework” (OF) as used herein refers to an electronic data structure comprising a plurality of content elements, where the content elements pertain to the functional and non-functional requirements required by the organization. The content elements in the organization framework can also include normative application security processes and elements and regulatory and compliance requirements pertinent to operation of the organization.

The term “Project Framework” (PF) as used herein refers to a subset of content elements from the OF, where the subset of content elements pertain to the functional and non-functional requirements relevant to a particular project. The project framework includes the set of requirements which are required for the specific project, and content elements in the organization framework system can be selected and applied to generate the set of content elements for the project framework. The project framework comprises the set of content elements in the non-functional requirements required for the project. The project framework can pertain to, for example, software development projects, software lifecycle projects, work initiatives, construction projects, legal projects, projects requiring demonstration of regulatory approval, or any project that needs to satisfy a standard or set of standards or policies for adequate completion. The PF can comprise content elements pertaining to functional as well as non-functional requirements.

The term “compliance requirement” as used herein refers to a requirement required to comply with a regulatory or legal standard. Each compliance requirement can be stored as a set of content elements in the organization framework.

The term “regulatory standard” as used herein refers to any rule, regulation, law, or policy that an organization needs to comply with and demonstrate compliance with. Regulatory standards can come from a wide variety of external organizations and can include but are not limited to: legal standards such as federal, provincial, state standards; federal standards from regulatory bodies including the Food and Drug Administration (FDA); professional standards such as those from Accountancy Associations, Legal Associations, Engineering Associations, and other professional organizations; customer derived standards; and other standards or external policies or combination thereof.

The term “regulatory compliance” as used herein refers to and describes the goal that organizations aspire to achieve in their efforts to ensure that they are aware of and take steps to comply with relevant laws, policies, rules, and regulations.

The term “organization policy” as used herein refers to a standard set by the organization that applies to all work and projects produced by the organization. Organization policies can include but are not limited to internal and external communication policies, social media policies, branding policies, accessibility policies, management processes, privacy protection, auditing, security, and internal organization policies, procedures, and guidelines.

Herein is described a system and method for establishing and maintaining an organization framework which comprises the non-functional requirements required for compliance with standards set by the organization, both internally and externally imposed. The present system and method for establishing and maintaining an organization framework creates a central repository of non-functional requirements for an organization for standardization of organizational operation and customization of projects throughout the lifecycle of the projects in the organization. The projects that the present organization framework can be applied to include regulatory projects, software applications, as well as non-software projects, and any project that requires compliance to regulatory standards and/or organization policies either internally or externally imposed in the organization. The present organization framework can be applied to the lifecycle and development of projects including software applications and software projects, and can also be applied to a wide variety of regulatory and other projects that have regulatory and non-functional requirements.

An organization framework is an electronic central requirements repository for an organization where all of the non-functional requirements for the set of projects being developed and maintained in the organization can be electronically stored, selected, customized, and updated. The requirements in an organization framework can be non-functional requirements as well as functional requirements and security processes. The present system and method are capable of handling compliance and non-functional requirements for standardization of operations and customization across an organization. By creating an electronic Organization Framework (OF), a digital master set of both compliance and organization non-functional requirements for an organization can be assembled once in a single location, such as in a database of content elements relevant to the set of non-functional requirements in the organization framework, then applied to every project produced by the organization, and updated across the organization throughout the lifecycle of each project. Project Frameworks (PF) applied to individual project applications can be linked to and draw from the organization framework such that when a requirement in the OF is updated, the same requirement will be automatically updated in every project framework that also has the same requirement, enabling a downward cascade of requirements updates to every project in the organization. In this way the organization can control compliance to a broad set of non-functional requirements across all of its platforms, projects, and products and throughout the lifecycle of all of its projects and software applications.

Non-functional requirements pertain to the properties of a project and how it functions or is intended to function once the project is completed. This is in contrast to functional requirements which generally pertain to the mechanism by which the desired result is obtained and/or defines how a system accomplishes the desired function or satisfies the functions of the project. Functional requirements can include, for example, the code and software functionality particularly pertaining to software application development, the hardware of a device or machine system, or other physical or material constraints of a project. Because non-functional requirements often require human evaluation or subjective evaluation and therefore cannot be coded or have automated machine checks to ensure compliance, it can be challenging to ensure that non-functional requirements are met, as well as complied with according to a timeline appropriate for the project and for the lifecycle scope of the project. Some examples of non-functional requirements include but are not limited to: accessibility; adaptability; auditability and control; availability; backup; capacity; current and forecast; certification; compliance; configuration management; cost, initial and life-cycle cost; data integrity; data retention; dependency on other parties; deployment; development environment; disaster recovery; documentation; durability; data retention; dependency on other parties; deployment; development environment; disaster recovery; documentation; durability; efficiency (resource consumption for given load); effectiveness (resulting performance in relation to effort); emotional factors (like fun or compelling or has “Wow! Factor”); environmental protection; escrow; exploitability; extensibility (adding features, and carry-forward of customizations at next major version upgrade); failure management; fault tolerance (e.g. Operational System monitoring, measuring, and management); integrability ability to integrate components; internationalization and localization; interoperability; legal (e.g. licensing issues or patent-infringement-avoidability); maintainability (e.g. Mean Time To Repair-MTTR); management; modifiability; network topology; open source; operability; performance and/or response time (performance engineering); platform compatibility; privacy (compliance to privacy laws); portability; quality (e.g. faults discovered, faults delivered, fault removal efficacy); readability; reliability (e.g. Mean Time Between/To Failures-MTBF/MTTF); reporting; resilience; resource constraints (processor speed, memory, disk space, network bandwidth, etc.); response time; reusability; robustness; safety or factor of safety; scalability (horizontal, vertical); security (cyber and physical); compatibility with software, tools, standards; stability; supportability; testability; throughput; transparency; usability or human factors) by target user community; and volume.

The presently described organization framework aggregates the set of compliance requirements and organizational policies into an electronic master set of requirements that provides all non-functional requirements required for any application or project in the organization in an electronic form and includes non-functional requirements to comply with both internal and external standards. The fundamental or master set of non-functional requirements for an organization can thus be compiled in the organization framework and applied to satisfy compliance as well as organizational policies, and serves as a master set of requirements for all organization policies and external standards. The present organization framework provides an effective and precise view of the requirements and characteristics for any project or software application in the organization in a single location and enables organizational customization at a high level to ensure compliance at all levels of the organization. Regulatory and quality assurance specialists can make use of the present organization framework to create system scalability and interface management as well as providing traceability for compliance to all required standards.

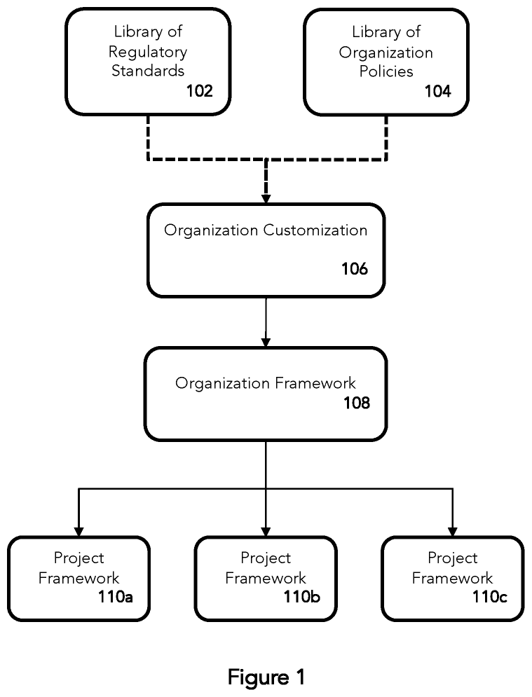

FIG. 1 is a flowchart depicting the structure of an organization framework for an organization. A library of regulatory standards 102 is compiled in an electronic form or database, where the regulatory standards are pertinent to the organization. The library of regulatory standards 102 comprises, in an electronic form, all of the compliance requirements that the organization is required to comply with for any project or application and all of the content elements pertaining to the compliance requirements. The library of regulatory standards 102 and associated compliance requirements as well as the library of organization policies 104 comprise the set of non-functional requirements within the organization framework. The regulatory standards can be extracted or taken from, for example, standards, regulations or regulatory standards, policies, laws, or a combination thereof, and converted into an electronic format, where each of the regulatory standards comprises one or more non-functional requirements which are also converted into an electronic format as a set of content elements. The electronic format of each regulatory standard and each organization policy can comprise, for example, the list of non-functional requirements for complying with the regulatory standard or organization policy and the content elements associated with each non-functional requirement, where each non-functional requirement has its own set of considerations to be addressed and complied with. Each organization will have its own set of regulatory standards based on its operations, structure, jurisdictional operation, business focus, customers, goals, etc. Each regulatory standard that needs to be complied with comprises a set of non-functional requirements which are required for compliance, and the library of regulatory standards can comprise both the functional and non-functional requirements associated with each regulatory standard. Regulatory standards and the associated non-functional requirements for the standard can also be gleaned from one or more external content library and applied at the organization level.

The digital library of organization policies 104 comprises the non-functional requirements that are established by the organization relating to organization objectives that are applicable for every project or product in the organization. Organization policies can include any non-functional requirements already referred to, for example but not limited to relating to branding, human factors such as accessibility, robustness, or any other non-functional requirement that the organization has set a requirement to meet for all projects in the organization. The organization can also have custom interpretations of regulations or more stringent or detailed reporting requirements that they want to include in the organization framework. Organization customization 106 can be added to any requirement, with recordability of the customization and type of customization such that it can be retained in requirements updates. Customization for an organization's non-functional requirements can include modifying certain attributes so that the language or details more closely resemble internal guidelines or style. For example, the “priority” or importance of a non-functional requirement may be higher or lower than its default value. Customization allows an organization to bring a localized importance to the work. The “description” or “title” of a non-functional requirement may also be customized in an Agile-based organization. For certain teams, certain content may be better worded in User Story language, such as “As a user I want to . . . so that I can . . . ”. This is useful because end-users who must action the content or implement non-functional requirements are trained to execute instructions that are laid out in such a manner.

An organization framework 108 aggregates all non-functional requirements in the organization from the library or set of regulatory standards 102 and the library or set of organization policies 104, with organization customization 106 applied to any non-functional requirement as desired by the organization. Once assembled, the organization framework 108 can be used to assemble a plurality of project frameworks 110a, 110b, 110c for individual projects, wherein the non-functional requirements in each plurality of project frameworks 110a, 110b, 110c are linked to the master copy of the non-functional requirement in the organization framework 108, optionally customized by the organization customization, as stored in the organization framework. Selection of non-functional requirements for each project framework can be based on the type of project, functionality of the project, etc. Future updates to any requirement can be pushed down from the organization level through the organization framework 108 and into the project frameworks, ensuring that all requirements in the organization remain up-to-date, with the simplification of allowing updating of requirements in the master organization framework 108 reflecting in the updated requirements in every project framework throughout the organization.

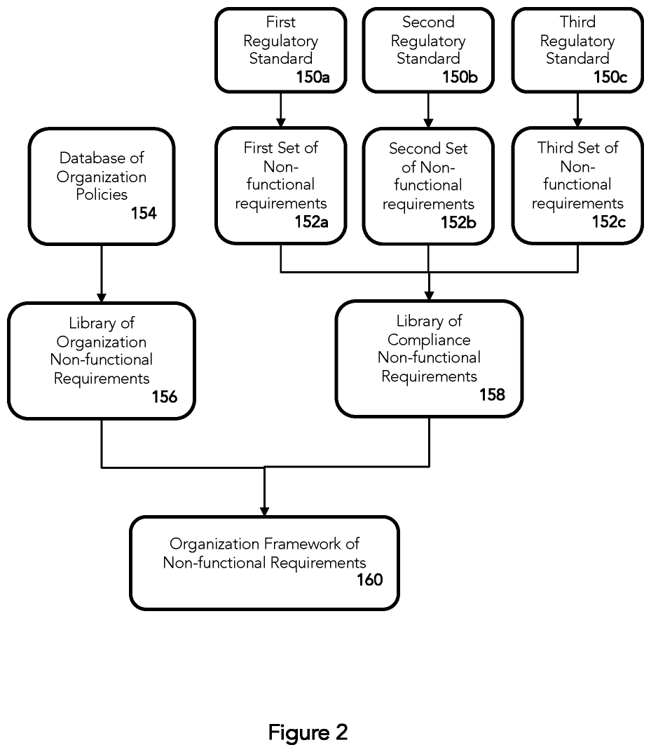

FIG. 2 is a system overview of an organization framework of non-functional requirements for an organization. As shown in FIG. 2, the creation of an organization framework of non-functional requirements 160 comprising a master set of non-functional requirements required for compliance of any project or application in the organization depends on the assembly of a library of organization non-functional requirements 156 and extraction of a library of compliance non-functional requirements 158 from a plurality of regulatory standards, such as first regulatory standard 150a, second regulatory standard 150b, and third regulatory standard 150c. It is understood that there may be one or more applicable regulatory standards, up to a very large number of regulatory standards for larger projects. A plurality of regulatory standards 150a, 150b, 150c can be considered and parsed to extract all relevant compliance non-functional requirements. In the case shown in FIG. 2, a first set of compliance non-functional requirements 152a is extracted from a first regulatory standard 150a, a second set of compliance non-functional requirements 152b is extracted from a second regulatory standard 150b, and a third set of compliance non-functional requirements 152c is extracted from a third regulatory standard 150c.

In the case of software applications, a variety of regulatory standards apply to software applications in public use, and these standards must be complied with throughout the software lifecycle. For example, if the software application is used within a financial institution having credit card transactions, applicable regulatory standards would include regulations and control frameworks such as the Payment Card Industry Data Security Standard (the “PCI DSS”), COBIT, ISO 27001 (formerly 17799), Gramm-Leach-Bliley Act (GLBA), and the like. In another example, if a project is related to the healthcare industry, privacy regulations for medical data apply, and can be jurisdictional based on where the project or application is being used. In this example, organization policies for a project relating the acquisition and storage of personal medical records must comply both with regulatory standards as well as any heightened or internal organization requirements in order to maintain security and compliance. The same can be applied to non-software applications where regulatory standards must be complied with and non-functional requirements addressed for compliance with these standards. The regulatory standards can apply to various regulatory domains which include but are not limited to health, insurance, education, security, banking, software development, and pharmaceutical compliance.

In any given application or project development which requires compliance to a plurality of regulatory standards there is a high probability of overlap in the requirements needed to comply with each of those standards. In particular, various regulatory standards may apply to a project and may require some of the same information, such as, for example, location of data storage, individual file identification standards, and storage timeline. Each regulatory standard can be parsed to extract a library of non-functional requirements specific to that standard, and comprise a set of non-functional requirements pertaining to the first, second, and third regulatory standard, respectively. By doing this for the plurality of regulatory standards 150a, 150b, 150c, to be complied with and compiling all of the non-functional compliance requirements for the plurality of standards into a library of compliance non-functional requirements 158, a single workflow can be created which provides a master set of all compliance requirements in a single organization framework of non-functional requirements 160. In one example, the requirement to cite the data storage location in a multitude of regulatory standards can be complied with once and applied to each standard for compliance with those standards. This lessens the need for inputting the same data multiple times for the multitude of required standards for compliance avoiding duplication and ensures that the compliance data supplied is consistent across all compliance standards for the project, as well as for the organization. On the organization side, organizations can select non-functional requirements from a database of organization policies 154 to incorporate into their own organizational non-functional requirements for all projects, which become part of a library of organization non-functional requirements 156 of the organization, optionally with customization. The organization non-functional requirements, once met, can thereby be applied across multiple compliance requirements and standardized throughout the organization. A regulatory standard requires compliance with the set of non-functional requirements identified as part of the regulatory standard. In addressing each non-functional requirement in a regulatory standard, recordal of compliance can be done at a project level, to provide a compliance audit to all the required regulatory standards and parts thereof and also provide an audit report of compliance to each regulatory standard at any time during the application or project lifecycle.

Each non-functional requirement comprises a plurality of content elements which provide the details for the non-functional requirement, with each content element having a particular content type. A content type is a data template composed of a set of attributes {a₁, . . . , aₙ} describing a class of information. A content element is an instance of a content type. For example, some content types can describe the work instruction or non-functional requirement itself, and can contain attributes such as title, description of the NFR, implementation details, priority, any associated problems or references to other content elements of type problem. At least one content element also comprises the applicability rules, which is a set of one or more conditions under which the NFR is applicable, or set of conditions when the task T is applicable to a work project. In the selection of which non-functional requirements are applicable to a project, an evaluation is done to determine whether the applicability rules of the NFR is satisfied by the project context. In one example, a content element <title>will contain the title of the NFR, which is a high level instruction describing the work and a body of text that provides high level detail on how the system or product would be or behave if the requirement is met. Other content types can be related to the problem or problems solved by the NFR, or describe a problem that may manifest in a work project. These content types can contain attributes such as the problem definition, external references identifying the problem, relationships to other content elements or external details related to this problem for example Common Weakness Enumeration (CWE), and applicability rules such as a set of conditions when the problem P is applicable to a work project. Other content types can be related to solving a problem or addressing the NFR. These content types can, for example, describe or provide specific ‘How-To’ implementation detail related to a task T for addressing the NFR, and can contain attributes such as implementation details, external references, links to related guidance or supporting information, applicability rules, and a set of conditions when this How-To H is applicable to a work project. Other content types can also contain acceptance criteria or conditions that need to be met for the NFR, such that it would be clear whether or not the non-functional requirement has been met.

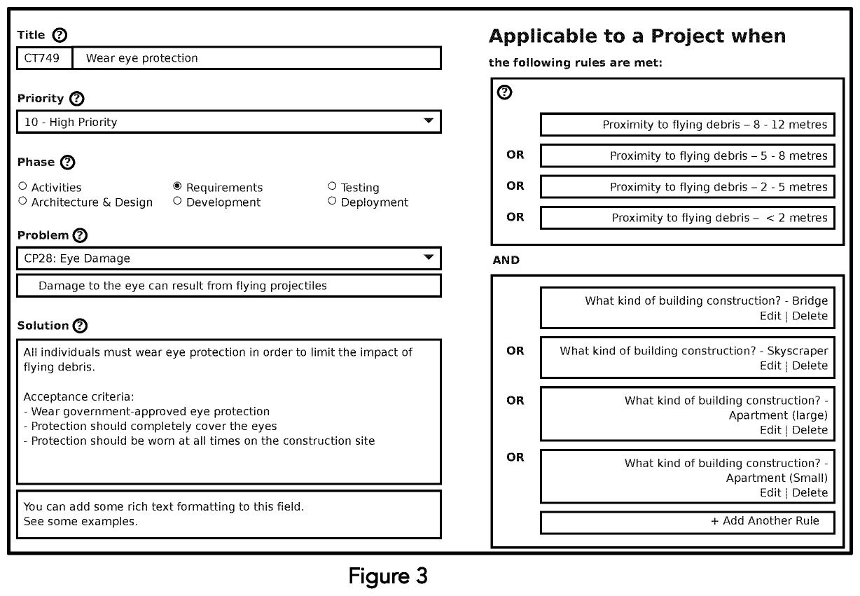

FIG. 3 is an entry for a non-functional requirement having a plurality of content elements. In the example, for a non-functional requirement such as “Wear Eye Protection” which is applicable to a construction site, the NFR may include, for example, a list of suitable eyewear that every person must wear on a construction site, such as CSA approved eyewear. The list of suitable eyewear may be derived from a regulatory standard covering safety requirements for workers on construction sites, and may have come from, for example, a jurisdictional law, union regulation, or industry best practices standard. For a project having a construction component, the NFR “Wear Eye Protection” could be added to the project to ensure that the requirement is clearly set out such that the acceptance or compliance criteria are met for the project. The NFR for “Wear Eye Protection” may be dictated from local or national worker safety groups, however an organization may decide that they want increased vigilance and safety compared to industry standards or requirements. In this case, the organization could make a customization to the “Wear Eye Protection” NFR to require that eyewear be of a heightened standard. Customizing the NFR centrally in the database of Organization Policies would then update every project containing the “Wear Eye Protection” NFR so that all projects are following the updated standard. Providing a compliance requirement checklist or indication of compliance can ensure that judging of compliance to the NFR is clear, reasonable, and reportable. Rules of applicability of the standard can also include one or more conditions where the NFR would apply, such as proximity to flying debris, or type of construction project. The same or similar NFR could also apply to other types of projects such as, for example, painting, laboratory, manufacturing, food processing, or other environments where eye safety must be considered.

Each non-functional requirement can further comprise a compliance constraint that the non-functional requirement must satisfy to comply with a particular standard. A compliance constraint refers to a numerical limit or range pertaining to the non-functional requirement that is required to comply with a standard. To demonstrate compliance with each non-functional requirement, the system can further allow reporting of a compliance constraint associated with the non-functional requirement. This maintains a record of the status of each non-functional requirement as applied to a particular application or project and can provide additional data for data collection, tracking, and auditing purposes. The compliance constraint can be a data entry field that is a binary data field (yes/no), data range (numerical indicator from x to y) or specific data field (a particular number) and can be compared against the organization framework requirements to confirm compliance. The compliance constraint can also be time-bound, such as indication of compliance is required weekly, daily, annually, etc.

The non-functional requirements in the organization framework of non-functional requirements can be tagged or organized by, for example, regulation, theme, non-functional requirement category, project timeline, applicability to a standard or class of standards, or a combination thereof. In this way, an organization can elect to include external sets or libraries of non-functional requirements as part of their organization framework that are relevant to their organization, but not others.

The database structure of each organization's unique organization framework can also consist of a plurality of individual content packs, where each content pack (CP) pertains to a plurality of non-functional requirements relating to the particular theme or subject matter of the content pack. Each content pack can be classified and tagged in order to provide ease of selection of non-functional requirements that are pertinent to the organization or organization project portfolio. Preferably, the content pack comprises a set of content element modifications or customizations to the non-functional requirements contained in the library of organization non-functional requirements and the library of compliance non-functional requirements as a set of changes. The content pack can thus indicate the additions, subtractions, and customizations made by an organization to a set of non-functional requirements, and these changes can be stored in a pared down changes data structure for ease of storage, notification, and update. In one case removing content from a content library is useful when an organization wishes to change the scope of requirements or eliminate requirements from its organization framework. The applicability rules of a non-functional requirement can also be defined to affect work products under certain circumstances. An organization can eliminate these rules and create its own rules, expanding or limiting the scope of a requirement. When an organization or team chooses not to implement all of a regulation or policy, it can remove certain requirements. This is useful for organizations or teams that are not subject to an external regulation but seek to fulfill it. Certain regulations may be expensive to implement and so the organization or team can opt out of them by removing the content.

Consider an organization that relies on an external content library for its guidelines and best practices for building bridges. This external library CP1 tracks city, and other jurisdictional requirements. The organization has an additional requirement for its own staff during construction and is tracked as CP2. The final set of requirements in the content pack CP are calculated as CP1+CP2, where CP is the set of modifications to the non-functional requirements from the external library CP1 and to the internal organization library CP2. When the city or other jurisdiction updates its requirements, the external content library CP1 is released as CP1′, where CP1′ denotes the changes made in the update of the external content library to the existing set of non-functional requirements in the external content library. When the organization receives the update, it can apply its content pack CP2 to CP1′ to yield CP1′ +CP2 to generate a new and updated content library containing the updated jurisdictional requirements as well as its own. In a specific example, if the organization is a business law firm operating in Arizona, content packs associated with state law (Arizona) and federal law (United States) can be selected from a library of regulatory non-functional requirements and applied to the organization framework for that law firm. Other non-legal non-functional requirements may also apply to or be opted-in by the organization concerning best practices that can also be supplied as content packs. A “best practices for US legal businesses” content pack can, for example, contain non-functional requirements such as, for example, accessibility, documentation, file handling, and electronic communication, and can be applicable to any legal firm. An update resulting from a new legal decision can change content elements in one or more non-functional regulatory requirement and the update can be provided as a content element change to the organization framework to update those particular content elements.

An advantage to the presently described organization framework is that organizations can assemble their own custom master list of requirements based on the individual operations of the organization using selected content packs that contain sets of non-functional requirements specific to their business. As a comparison, a software development organization concerned with satisfying privacy requirements in a piece of software code in a specific jurisdiction (e.g. General Data Protection Regulation (GDPR) regulations in Europe) will want to refer to a set of requirements specific to these regulations, which are unlikely to apply to daily practice of the law firm in Arizona. Selection of organization-specific requirements specific to an individual organization to generate an organization framework of non-functional requirements assists organizations to ensure up-to-date compliance to regulatory standards as well as consistent application of organization policies.

The Content Element Universe (CEU) is the set of content elements possible in the Organization Framework, and the Organization Framework contains a subset of all possible content elements in the CEU. The organization selects sets of content elements, also referred to as content packs, based on the non-functional requirements applicable to their organization. Each non-functional requirement comprises a plurality of content elements categorized by content type, with each content element providing defining information on the specific indications of application of the non-functional requirement. In one specific example, the Content Element Universe (CEU) can be defined as the set of Content Element items describing and contained in all non-functional requirements in the library of non-functional requirements:

CEU={R1, R2, . . . , Ri, S1, S2, . . . , Sj, . . . , P1, P2, . . . , Pk} in one case, where:

R represents i (i>=0) organization, country, or international regulations S represents j (j>=0) organization, country, or international standards, and P represents k (k>=0) organization, country, or international policies

Sets R, S, and P can include, for example, but are not limited to work items, tasks, standards, regulations, security requirements, accessibility best practices, and any other non-functional requirements or standards either internal or external that comprise non-functional requirements. Sets R, S, and P in this case are exemplified as jurisdictional application of certain content elements, however the content element universe also comprises content elements categorized by, for example, industry, audience, platform, project, etc.

A Content Element E can be a tuple of A+1 attributes as follows:
E=(id, attribute1, attribute2, . . . , attributeA)
   where id is a unique identifier that differentiates E among other Content Element items in the Content Element Universe. Content Elements can be tracked in a content library for ease of modification and sharing. A content library can be defined, for example, as a subset of the Content Element Universe. A Content Library (L) is a set of n Content Element ei (1<=i<=n) items such that each Content Element (ei) is of m distinct Content Type tj (1<=j<=m) values:
L={e1, e2, . . . , ei, . . . , en; 1<=i<=n}

where ei is one of {t1, t2, . . . , tj, . . . , tm; 1<=j<=m} Content Types. A Content Type tj is composed of an ‘id’ attribute as well as w attributes {a1, a2, a3, . . . , aw; w >=0} which further describe the instance of tj. The ‘id’ attribute is unique amongst Content Element ei items of type tj in the Content Library L.

Consider a Content Library (L) made up of k Requirement Content Type R elements. R has A+1 attributes as follows, where A=3.
L={r1, r2, . . . , rw, . . . , rk} where 1<=w<=k and R can be, for example, a Content Type with four attributes:
id-unique identifier
title-name of the Requirement
priority-numeric value indicating importance
description-details about the Requirement

The Content Library L for an organization can be expressed as a result of a set of transformations (also referred to as modifications and customizations) that are performed on the initial instance of the content library LO, where the transformations are recorded in a content pack CP as changes to specific content elements in the content library:
L=LO+Content Pack (CP)
CP=(M, o1, . . . , op, . . . , oF) 0 <=p<=F where:

M is metadata or information about a content pack CP, and

(o1, . . . , oF) is a set of F elements, op, where op is an operation that adds, removes, or

updates a content element in LO

Library LO can be modified to create a new or updated Organization Framework by selecting certain content elements, removing certain content elements, and/or changing certain content elements, by applying the set of transformations in the content pack to provide a customized library L for the Organization. Applying a Content Pack CP to an existing Content Library L generates a new content library, or new iteration of the previous content library. This is advantageous in practice, as adding a new content pack to an existing content library can effectively conserve the content of the previously existing content library such that the new content library preserves any added modifications or augmentations made by the organization or user to customize the content library.

Consider a content library L1 having k=2 requirement Content Elements (R1 and R2) which can be expressed in JavaScript Notation (JSON) as:

```
L1 = [
{″id″: ″R1″, ″title″: ″Requirement 1″, ″priority″: 10,
  ″description″: ″Requirement 1 description″},
  {″id″: ″R2″, ″title″: ″Requirement 2″, ″priority″: 9,
″description″: ″Requirement 2 description″},
]
```

The content library L1 can be denoted as:
1={ }+CP1
   where { } is the empty content library and CP1={o1, o2} are two add operations for adding content elements R1, R2, respectively, to the content library L1, where the content elements R1 and R2 are called up from a content element database.
   CP1 can be expressed in JSON format:

```
{
  ″metadata″: {
    ″id″: ″content.pack.CP1″,
    ″hash″: ″00001″,
    ″title″: ″Content pack CP1″,
    ″description″: ″This is the description of
    the content pack
CP1″
  },
  ″data″: [{
    ″op″: ″add″,
    ″id″: ″R1″,
    ″value″: {
      ″title″: ″Requirement 1″,
      ″priority″: 10,
      ″text″: ″Requirement 1 description″
    }
  }, {
    ″op″: ″add″,
    ″id″: ″R2″,
    ″value″: {
      ″title″: ″Requirement 2″,
      ″priority″: 9,
      ″description″: ″Requirement 2 description″
    }
  }
  ]
}
```

The library L1 generated by CP1 is identified by hash=00001. L1 can be defined or updated in two main ways via a Content Pack, by Content Pack re-definition, and by Content Pack customization. A Content Library is redefined when its generating Content Pack is redefined. A Content Library is modified or customized when there are changes or removals of existing content elements, or addition of new elements via a Content Pack or other mechanism.

For library definition or re-definition, a library having hash=H is redefined by applying a Content Pack with metadata having the same hash=H. Consider L expressed with s elements:
L={r1, r2, . . . , rs}

An equivalent form is as follows:
L={ } +CP
   where CP is a Content Pack defined as:
CP=(m, o1, o2, . . . os)
   with s add operations and having metadata m with id=D and hash=H. By changing the underlying details of CP but keeping its id=D and hash=H, L can be redefined as:
L={ }+CP′
   where CP′ is a Content Pack defined as:
CP′ =(m′, 01, o2, . . . ou)
   with u add operations and having metadata m′ with id=D and hash=H.

For library modification, consider Library L expressed with s elements:
L={r1, r2, . . . , rs}
   L can be redefined as L′:
L′ ={r1, r2, . . . , rs} +CP
   where CP is a Content Pack defined as:
CP=(o1, o2, . . . ob)

With b add, remove, or replace operations, b>=O, such that L′ is expressed as follows:
L′ ={r1, r2, . . . . . . , rq}
   where,
0<=q<=(s+b)

An example is provided for updating existing non-functional requirements in a content library, where the library contains a set of non-functional requirements and the content elements associated with those non-functional requirements, and the updating of the content library is accomplished by applying a set of operations for a subset of the content elements using instructions in a content pack. Consider content library L2:

```
L2 = [
  {″id″: ″R1″, ″title″: ″Requirement 1 - updated″, ″priority″: 3,
″description″: ″Requirement 1 description″},
  {″id″: ″R2″, ″title″: ″Requirement 2″, ″priority″: 9,
″description″: ″Requirement 2 description″},
]
```

L2 is an update to L1, L1 as defined above, with modifications to the “R1” element. L2 can be expressed as:
L2=L1+CP2
   where,

```
CP2 = {
  ″metadata″: {
    ″id″: ″content.pack.CP2″,
    ″hash″: ″00002″,
    ″title″: ″Content pack CP2″,
    ″description″: ″This is the description
    of the content pack
CP2″
  },
  ″data″: [{
    ″op″: ″replace″,
    ″id″: ″Rl″,
    ″value″: {
      ″title″: ″Requirement 1 - updated″,
      ″priority″: 3
    }
  }]
}
```

The new Content Library L2, generated by CP2, is identified by hash=00002.

For removals from an existing Content Library, consider L3:

L3 = [
{″id″: ″R2″, ″title″: ″Requirement 1″, ″priority″: 9,
″description″: ″Requirement 2 description″},
]

L3 is an update to L1, L1 as defined above, with the “R1” element removed. L3 can also be expressed as:
L3=L1+CP3
   where,

```
CP3 = {
  ″metadata″: {
    ″id″: ″content.pack.CP3″,
    ″hash″: ″00003″,
    ″title″: ″Content pack CP3″,
    ″description″: ″This is the
    description of the content pack CP″
  },
  ″data″: [{
    ″op″: ″remove″,
    ″id″: ″R1″
  }]
}
```

The new Content Library L3, generated by CP3, is identified by hash=00003.

For addition to an existing Content Library, consider L4:

```
L4 = [
  {″id″: ″R1″, ″title″: ″Requirement 1″, ″priority″: 10,
″description″: ″Requirement 1 description″},
  {″id″: ″R2″, ″title″: ″Requirement 2″, ″priority″: 9,
″description″: ″Requirement 2 description″},
  {″id″: ″R3″, ″title″: ″Requirement 3″, ″priority″: 8,
″description″: ″Requirement 3 description″},
]
```

L4 is an update to L1, L1 as defined above, with a new element “R3”. It can be expressed as:
L4=L1+CP4
   where,

```
CP4 = {
  ″metadata″: {
    ″id″: ″content.pack.CP4″,
    ″hash″: ″00004″,
    ″title″: ″Content pack CP4″,
    ″description″: ″This is the description
    of the content pack
CP4″
  },
  ″data″: [{
    ″op″: ″add″,
    ″id″: ″R3″,
    ″value″: {
      ″title″: ″Requirement 3″,
      ″priority″: 8,
      ″text″: ″Requirement 3 description″
    }
  }]
}
```

The new Content Library L4, generated by CP4, is identified by hash=0 0 0 0 4.

Having regard to content relationships, a Content Element item E can reference attributes tracked by another Content Element F. Consider Content Element E having A attributes; including d dependencies:
E=(id, attribute1, . . . , attributej, attributej+1, . . . , attributed, attributed+1,. . . , attributeA)
   where
1<=j+d<=A

The d dependencies reference at most d other distinct Content Elements.

As an example, consider the case where a content library contains a set of regulations, and each regulation is associated with a particular country. This situation may occur, for example, in a content library pertaining to import/export of pharmaceutical products across international borders, where each importing and exporting country will have its own set of regulations based on a variety of factors which may include type of pharmaceutical, pharmaceutical form, destination country, recipient, etc. In a particular project for export from country C1 to import at country C2, the union between the requirements for each country can be added to a project framework. Should a particular regulation be updated during the course of the project, a modification to one or more content elements in the requirements can be updated posthaste by applying an updated content pack to the organization framework with the changes to the relevant content elements which will be applied to the project in progress.

In an example, consider a content element Rj from the set of regulation content element items {R1, R2, . . . , Rj, . . . , Rg}, having g elements. Content element Rj can reference a country Ci in the content library as an attribute. Rj, and can be expressed as:
Rj=(id: Rj, a1, a2, . . . , aA-1, Ci)
   where Ci is from the list of all Country Content Elements:
Ci=(id: Cj, ac1, ac2, . . . , acY)
   and where (ac1, ac2, . . . , acY) are Y attributes for the Country Content Element identified by Ci. Therefore, a Content Library L having such an inter-relationship between the set of n Regulation and k Country Content Elements can be expressed as:
L={R1, R2, . . . , Rn, C1, C2, . . . , Ck}
   where
Rj=(id: Rj, a1, a2, . . . , aA-1, Ci); 1<=j<=n
   and
Ci=(id: Ci, act, ac2, . . . , acY); 1<=i<=k

In another example, consider the following library L5:

```
L5 = [
  {″id″: ″R1″, ″title″: ″Requirement 1 - updated″, ″priority″: 3,
″description″: ″Requirement 1 description″},
  {″id″: ″R2″, ″title″: ″Requirement 1″, ″priority″: 9,
″description″: ″Requirement 2 description″},
  {″id″: ″C1″, ″name″: ″Canada″, ″population″: 30000000},
  {″id″: ″C2″, ″name″: ″United States″, ″population″: 300000000},
]
```

R1 and R2 can be associated to C1 and C2, respectively, with the following JavaScript Notation (JSON) format:

```
L6 = [
  {″id″: ″R1″, ″title″: ″Requirement 1 - updated″, ″priority″: 3,
″description″: ″Requirement 1 description″, ″country″: ″C1″},
  {″id″: ″R2″, ″title″: ″Requirement 1″, ″priority″: 9,
″description″: ″Requirement 2 description″, ″country″: ″C2″},
  {″id″: ″C1″, ″name″: ″Canada″, ″population″: 30000000},
  {″id″: ″C2″, ″name″: ″United States″, ″population″: 300000000},
]
```

A content element can also be assigned a content condition attribute that evaluates or determines input and indicates inclusion or exclusion for any request or “content library selection” for a content element item from the content library. The content condition provides an applicability rule to determine whether the content element is applicable for inclusion in a given work project. In one example, the inclusion of any of a plurality of non-functional requirements in a library of non-functional requirements for a project will be based on the content condition for each non-functional requirement and the project context. The project context for a project can include properties about the project, which are matched to content elements to determine if the content element is applicable to the project. Content condition elements can comprise dependency attributes that are tracked by a content element. Consider content element Rj having a content condition Cw:
Rj=(id: Rj, a1, a2, aA-1, Cw); 1<=j<=n
   where a1, a2 . . . aA-1 are content attributes, and Cw is the content condition under which the content element Rj is applicable. In an example content condition Cw can pertain to jurisdiction=Germany, and if the project context includes jurisdiction=Germany then Rj may be applicable to the project if all other relevant conditions are met for the content element. Content elements can have zero, one, or more than one content condition governing whether the content element is applicable to the project. For example:
Cw=(true if project condition is satisfied by project context X; otherwise false)

The content condition Cw is evaluated against each project context X to determine if the content condition Cw applies to the particular project framework, and in particular to content element Rj. If the project context condition is satisfied, then the content element Rj is added to the project framework.

Projects comprise multiple project context elements which describe the nature and attributes of the project. In one example, the set of project context elements can be defined as:
X=(x1, x2, . . . , xq, xT); 1<=q<=T
   where X is a set of project context elements x1, x2, . . . xq . . . xT. A project context element xq can be expressed as, for example, a characteristic of an initiative, project, work, or real-world artifact. These can map to different industries, areas or use cases; such as, for example application software, general business, jurisdiction, or pharmaceuticals. In each case, the project context element can designate a context condition or characteristic specific to the project. In the case where the project context specifies the type of application software, relevant project context elements can indicate that the programming language used is Java; the application is deployed in Amazon AWS; and that the application stores information in a database. Other project context elements pertaining to the general business of the project can apply when the project is, for example subject to laws of Europe (for example, or other jurisdiction), or that the work is for the finance business unit in the organization. Yet other project context elements can provide characteristics defining the scope of the project, for example if the project relates to pharmaceuticals, the project context element can be defined as a drug that targets liver cancer. Boolean logic can be used, such as a mathematical expression composed of AND, OR, NOT, to evaluate whether the content condition of the content element in the NFR containing the content conditions is met by the project context by comparing it to the set of project context elements.

In another example, consider a Content Library L7 below described in JavaScript Notation (JSON) format:

```
L7 = [
  {″id″: ″R1″, ″title″: ″Requirement 1 - updated″, ″priority″: 3,
″description″: ″Requirement 1 description″, ″country″: ″C1″},
  {″id″: ″R2″, ″title″: ″Requirement 2″, ″priority″: 9,
″description″: ″Requirement 2 description″, ″country″: ″C2″},
  {″id″: ″C1″, ″name″: ″Canada″, ″population″: 30000000,
″conditions″: [ ″flag-maple-leaf″]},
  {″id″: ″C2″, ″name″: ″United States″, ″population″: 300000000,
″conditions″: [ ″flag-stars-stripes″]},
  {″id″: ″H1″, ″title″: ″How-to 1″, ″description″: ″How-to
description″}
]
```

The Content Elements C1 and C2 are assigned a condition attribute having a list of matching input, where:

C1 is relevant when input contains “flag-maple-leaf”

C2 is relevant when input contains “flag-stars-stripes”

A project application with rules regarding display of images and text based on jurisdiction can be customized automatically when the jurisdiction conditions of the project are set, with branding and text rules originating from the organization framework. Thus if an image set changes in the organization framework, the same can be automatically updated in the project framework and the project output.

Content Packs can build upon other Content Packs so that customization is isolated to smaller self-contained definitions but together generate a customized Content Library. Consider Content Library L8 defined as:
L8={ }+CP8
   Where CP8 is a Content Pack that defines L8. A new Content Library L9 that customized L8 can be expressed as:
L9=L8+CP9
   such that CP9 is a Content Pack composed of operations that customize and change the definition of Content Library L8. This is equivalent to:
L9={ }+CP8+CP9
   Content Packs CP8 and CP9 can be crafted, distributed and maintained separately but together they generate L9. In the definition of CP9, the metadata can define a dependency on CP8 and include operations to modify the Content Library generated by CP8. For example:

```
CP9 = {
  ″metadata″: {
      ″id″: ″content.pack.CP9″,
      ″hash″: ″00009″,
      ″title″: ″Content pack CP9″,
      ″description″: ″This content pack
      builds on content pack CP8″
    ″depends_on″: {
        ″hard″: [
          ″content.pack.CP8
        ],
        ″soft″: [
          ″content.pack.CP4
        ]
      }
  },
  ″data″: [{
      ″op″: ″add″,
      ″id″: ″R9″,
      ″value″: {
        ″title″: ″Requirement 9″,
        ″priority″: 2,
        ″text″: ″Requirement 9 description″
      }
  }]
}
```

In the above example “content.pack.CP8” is identified as a necessary Content Pack for use with Content Pack CP9 but “content.pack.CP4” is optional. Expressing a content library as a set of content packs, each content pack composed of a metadata and a set of add, change, or remove operations allows for a variety of potential benefits. In particular, the system and method as presently described is capable of breaking a very large library of non-functionality requirements into smaller, manageable self-contained, and re-distributable content packs. In addition, having a variety of content packs allows for multiple parties to maintain a large and detailed set of non-functional requirements with limited conflicts and need for direct collaboration and also solves conflicts that occur when merging customization of a non-functional requirement and any changes to its upstream version.

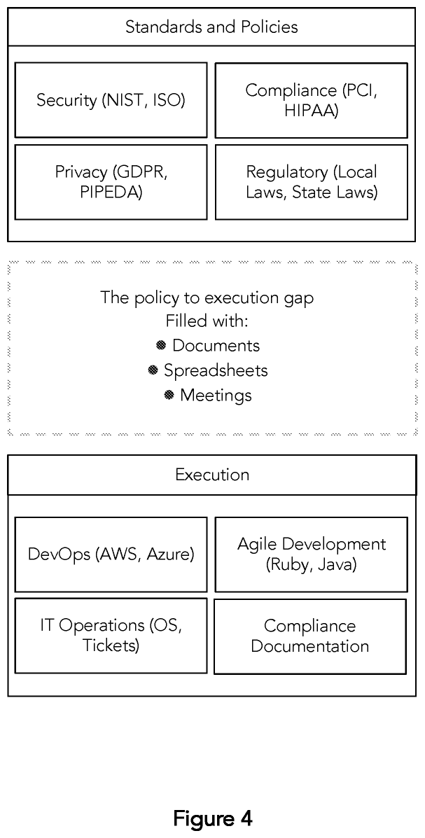

FIG. 4 illustrates the policy to execution gap in project compliance. As shown in FIG. 4, an organization will have a multitude of policies that are required for compliance for all of the projects in the organization portfolio. These policies include but are not limited to security policies, regulatory compliance policies, privacy policies, and legal regulatory policies.

The policies can be jurisdictional in nature, platform-related, or can be project specific relating to particular arrangements, relationships, or requirements agreed to by the organization for a particular project. A policy to execution gap often exists in project management where, for example, policy requirements are unclear, there is insufficient or incomplete tracking of policy compliance, where policies are satisfied more than once for an organization, and when backtracking for audit or reporting is required to demonstrate compliance. Mapping standards to work can cause errors and omissions if the approach to parsing each standard for its requisite non-functional requirements is not systematic. A mapping is needed between the standards and policies and their associated non-functional requirements and the execution of a project in order to satisfy all the contextually required standards and policies.

Compliance requirements and non-functional requirements can be indexed or organized in groups or content packs, wherein each content pack is specific to a specific type of compliance requirement or non-functional requirement. Compliance requirements can be organized, for example, as pertinent to a particular regulatory standard such that indication of the need for compliance with the standard in an application can enable selection of any compliance requirement or content pack relevant to the standard. In one example, a content pack of compliance requirements relating to the regulatory standard of European General Data Protection Regulation (GDPR) can be indexed as such in a content pack, and if an application is intended to be made available in Europe then the organizational GDPR-related compliance requirements, customized to the organization, can be routed directly from the organization framework and applied to the project framework for the application. In this way, an organization can obtain and apply only those content packs which pertain to the organization.

In another example, for a pharmaceutical project requiring demonstration of compliance to a variety of pharmacological and jurisdictional regulations in the form of compliance documentation, the library of compliance requirements can comprise the set of regulatory standards and their associated non-functional requirements. One example regulatory standard can pertain to import rules for pharmaceutical products, which vary by jurisdiction, and can even vary by province or state within countries. To obtain permission to import and sell pharmaceutical products in any jurisdiction all of the requirements must be demonstrated to the legal party governing permission to sell in that jurisdiction. The regulatory standard in any given jurisdiction may comprise similar non-functional requirements as other jurisdictions, however may be different in the reporting or compliance requirement to satisfy the standard. The present system centralizes the compliance requirements from multiple non-functional requirements such that the compliance requirements of multiple jurisdictions, for example, can be complied with simultaneously, and individual reports can be generated which are specific to each jurisdiction to satisfy each individual regulatory standard. In this example, the pharmaceutical company seeking to ensure that they have satisfied a set of reporting criteria for the purposes of drug regulation may apply a content pack specific to their business, whereas a content pack relating to application security for development of mobile applications may not apply to their business.

In the case of content library selection, a selection of content element items from a content library can be done in a direct or indirect way. In particular, for direct selection, a content element and its attribute values can be retrieved from the content library by id (identification). For indirect selection, Content Elements are selected according to the evaluation of the content element conditions, given an input of values. This can be expressed as:
L=L(direct)+L(indirect)
   where
L(direct) is a list of zero or many Content Elements identified by their id, and L(indirect) is a set of n input values vi: {v1, v2, . . . , vi, . . . , vn} 0 <=i <n

In an example, consider the following input of values, formatted in JSON:
[“flag-maple-leaf”]and content library L7. A new content library selection L8:
L8=L7(direct)+L7(indirect)
   where
L1 (direct)={H1}
   and
L7 (indirect)=[“flag-maple-leaf”]
   The system would evaluate the content condition items in L7, producing:

L7 (indirect)={R1}

Thus, L8 evaluates as a new content library:
L8={R1, H1}

The context relevant to an initiative, work effort, building construction or other project, can include but is not limited to: programming language (Java, C++, PHP, etc); jurisdiction (country, state, province, etc.); building materials (wood, steel, cement, plastic, etc.); team (number of persons involved in a project); environmental data (wind, temperature, amount of computer memory, diskspace, etc); and supporting technologies (Apache webserver, software framework). A content library selection is performed by an organization to generates the project framework for a project, so that the relevant non-functional requirements can be identified, tracked, executed, and tested.

The present organization framework can be stored on one or more computing devices with memory and may be accessed by wireless or a wired network, or a combination thereof. The network can be a collection of individual networks, interconnected with each other and functioning as a single large network (e.g., the internet or an intranet). The network can be implemented as one of the different types of networks, such as intranet, local area network (LAN), wide area network (WAN), the internet, and such. The network may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. The memory may be coupled to one or more processor(s) and can include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The system may also include one or more processors coupled with the memory to receive the organization framework and further configured to generate system processing commands. The processor may be implemented as one or more microprocessors, microcomputers, microcontrollers, digital signal processors, central processing units, state machines, logic circuitries, and/or any devices that manipulate signals based on operational instructions. Among other capabilities, the one or more processor is configured to fetch and execute computer-readable instructions stored in a memory.

The present system can also integrate with other application lifecycle management (ALM) tools which provide a work ticketing system to describe and prioritize developer work. In one embodiment, the organization framework or any subset thereof can be exported as a single software development guidance document or ALM tool, such as Atlassian JIRA™. In an ALM, the project framework can be synchronized with the ALM tool to allow stakeholders to push or prioritize requirements within the ALM tool into a team member's workflow. The team member can continue to work inside the ALM tool and as work is completed, the present system can be kept up to date with the status of corresponding work and requirements. A two-way synchronization between the present system and an ALM tool can enable developers and project managers to communicate and prioritize the work to team members in the system. An application programming interface (API) can also be used to build a custom application platform which can provide directed guidance and requirements particular to a project portfolio. The API gives external programmatic access to the data and behaviours of the system such that queries and instructions can be made to the system and the user can be presented with an updated task list. The team member can also export the requirements task list as a static electronic document.

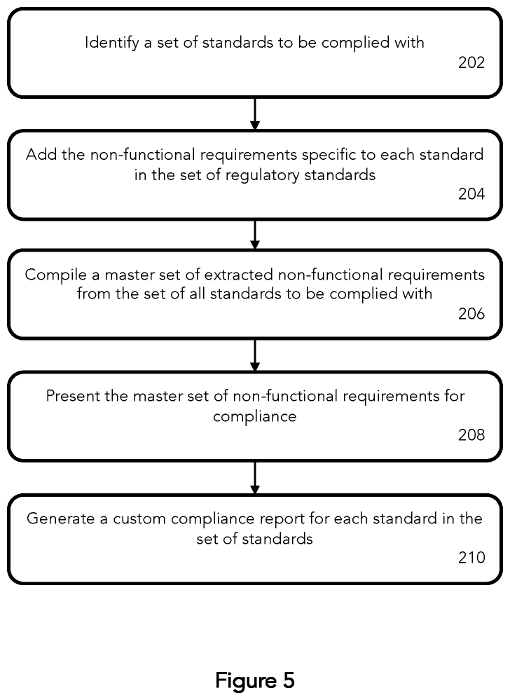

FIG. 5 is a flowchart depicting a method of generating an audit or compliance report for a regulatory standard. A set of standards to be complied with by the organization is identified 202. The non-functional requirements specific to each standard in the set of regulatory standards is added to the set of regulatory requirements for the organization 204. The adding of these requirements from a regulatory standard can be either by previously extracted requirements, or can be extracted from the standard and added, where each non-functional requirement has an associated set of content elements. A master set of added non-functional requirements from the set of all regulatory standards to be complied with is compiled 206, and the master set of non-functional requirements for compliance 208 is presented or processed for review and/or action within the organization, as described. A custom report for each regulatory standard in the set of regulatory standards 210 can then be generated for each application or project in the organization based on the requirements in the standard.

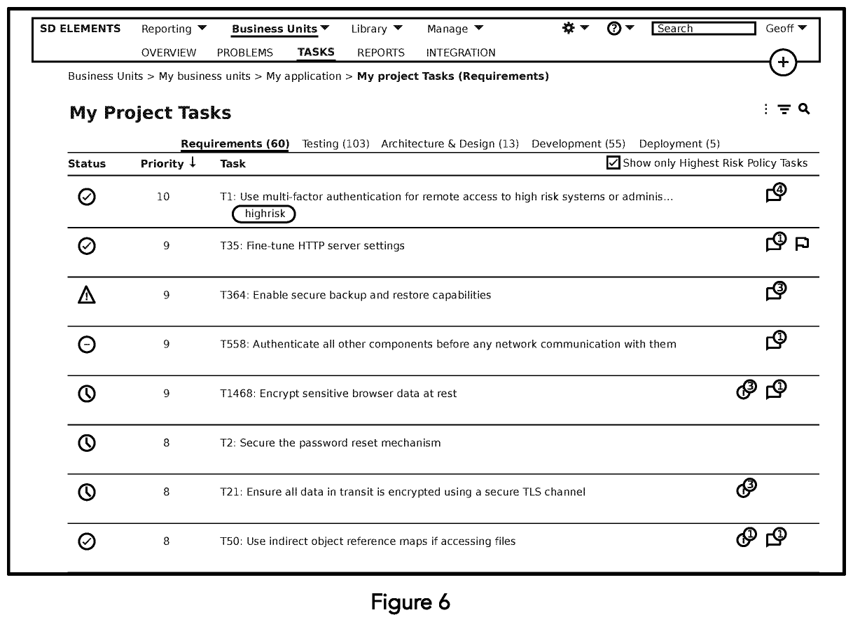

FIG. 6 is a representation of graphical user interface with prioritized task list of project tasks in a project framework. Display of requirements in the organization framework, or any subset thereof, such as in an project framework, can be available on a dashboard or project management software or application, and can be provided in any form useful to the organization or individuals working on the organization framework or requirements therein or as applied to a project as desired by the organization. Display of the organization framework or any subset thereof can also be in any form which way makes most sense to the user, such as, for example, grouped by non-functional requirements types, grouped by standard, grouped by jurisdiction, city/state/country, grouped by project using the non-functional requirement or project not in compliance with the non-functional requirement, or by any other grouping or tag. In this way, the organization framework puts forward the master set of compliance and organization requirements required to satisfy all of the regulatory standards in a single location, sorted in a format to expedite and ease compliance to all non-functional requirements in the organization.

The present method and system is described for the selection and modification of particularly non-functional requirements, however it is understood that the same can be used for content elements in a content database that are not non-functional requirements. In addition, the present system and method can be used for functional requirements in addition to non-functional requirements to provide a single organization framework for all requirements in an organization, streamlining organization efforts, updating of requirements, and reporting.

All publications, patents and patent applications mentioned in this specification are indicative of the level of skill of those skilled in the art to which this invention pertains and are herein incorporated by reference. The invention being thus described, it will be obvious that the same may be varied in many ways. Such variations are not to be regarded as a departure from the scope of the invention, and all such modifications as would be obvious to one skilled in the art are intended to be included within the scope of the following claims.

We claim:

1. A method for generating an organization framework of non-functional requirements, the method comprising:
storing an electronic library of organization non-functional requirements, each organization non-functional requirement comprising a plurality of content elements and derived from at least one organization policy;
storing an electronic library of compliance non-functional requirements, each compliance non-functional requirement comprising a plurality of content elements and derived from at least one regulatory standard, the regulatory standard applicable to at least one project in the organization;
applying an operational content pack to combine relevant non-functional requirements from the library of organization non-functional requirements and the library of compliance non-functional requirements into a single organization framework comprising a master set of non-functional requirements for the organization;
selecting a subset of non-functional requirements from the master set of non-functional requirements for one or more project framework, the subset of non-functional requirements pertinent to a particular project in the organization; and
providing the subset of non-functional requirements as a prioritized task list for completing the project.

2. The method of claim 1, further comprising customizing at least one non-functional requirement and storing the customization as a content pack comprising a set of content element modifications to the at least one non-functional requirement.

3. The method of claim 1, further comprising expressing the master set of non-functional requirements as a content pack comprising metadata and a set of transformations of the content elements in the library of organization non-functional requirements and the library of compliance non-functional requirements.

4. The method of claim 3, wherein the set of transformations comprise one or more additions, changes, and subtraction operations.

5. The method of claim 1, wherein the electronic library of compliance non-functional requirements is an external content library.

6. The method of claim 1, further comprising applying more than one operational content pack to combine relevant non-functional requirements from the library of organization non-functional requirements and the library of compliance non-functional requirements.

7. The method of claim 6, wherein at least one of the more than one operational content packs is specific to a regulatory domain.

8. The method of claim 7, wherein the specific regulatory domain is selected from one or more of health, insurance, education, security, accounting, law, importation, exportation, jurisdictional laws, professional requirements, banking, software development, software security, privacy, and pharmaceutical compliance.

9. The method of claim 1, further comprising updating at least one non-functional requirement and pushing the updated non-functional requirement to one or more project framework.

10. The method of claim 9, further comprising updating at least one compliance non-functional requirement, wherein the compliance non-functional requirement update is based on a change in the regulatory standard.

11. The method of claim 1, wherein the regulatory standard is all or part of a legal standard, security standard, financial standard, federal law, provincial law, state law, municipal law, regulatory body standard, accounting standard, or combination thereof.

12. The method of claim 1, further comprising generating an audit report on organization compliance with at least one regulatory standard.

13. The method of claim 1, wherein the subset of non-functional requirements in the project framework satisfies all of the compliance and organization non-functional requirements of the project.

14. An organization framework system comprising:
a content library of compliance requirements comprising a plurality of compliance non-functional requirements, each compliance non-functional requirement comprising a plurality of content elements, and derived from at least one regulatory standard;
a content library of organization policies comprising a plurality of organization non-functional requirements, each organization non-functional requirement comprising a plurality of content elements, and derived from at least one organization policy;
an operational content pack comprising instructions for combining relevant non-functional requirements from the library of organization non-functional requirements and selected non-functional requirements from the library of compliance non-functional requirements;
an organization framework comprising a master set of non-functional requirements for the organization based on the combining instructions of the operational content pack; and
a project framework comprising a subset of non-functional requirements pertinent to a particular project in the organization, wherein the subset of non-functional requirements satisfies all of the compliance and organization non-functional requirements of the project.

15. The system of claim 14, wherein at least one of the plurality of compliance non-functional requirements is customized for the organization.

16. The system of claim 14, wherein the subset of non-functional requirements in the project framework are selected based on content conditions in one or more content elements.

17. The system of claim 14, wherein at least one of the plurality of compliance non-functional requirements comprises a compliance requirement and at least one compliance constraint.

18. The system of claim 14, wherein an update to at least one non-functional requirements in the master set of non-functional requirements is expressed as a set of transformations of the content elements in the at least one non-functional requirement.

19. A computing device comprising a processor and a memory coupled to the processor, wherein the processor is configured to execute programmed instructions stored in the memory to:
store an electronic library of organization non-functional requirements, each organization non-functional requirement comprising a plurality of content elements and derived from at least one organization policy;
store an electronic library of compliance non-functional requirements, each compliance non-functional requirement comprising a plurality of content elements and derived from at least one regulatory standard, the regulatory standard applicable to at least one project in the organization;
apply an operational content pack to combine relevant non-functional requirements from the library of organization non-functional requirements and the library of compliance non-functional requirements into a single organization framework comprising a master set of non-functional requirements for the organization;
select a subset of non-functional requirements from the master set of non-functional requirements for one or more project framework, the subset of non-functional requirements pertinent to a particular project in the organization; and
provide the subset of non-functional requirements as a prioritized task list for completing the project.

20. A non-transitory computer-readable storage medium having one or more instructions thereon for identifying software application vulnerabilities during a software lifecycle, the instructions when executed by a processor causing the processor to:
store an electronic library of organization non-functional requirements, each organization non-functional requirement comprising a plurality of content elements and derived from at least one organization policy;
store an electronic library of compliance non-functional requirements, each compliance non-functional requirement comprising a plurality of content elements and derived from at least one regulatory standard, the regulatory standard applicable to at least one project in the organization;
apply an operational content pack to combine relevant non-functional requirements from the library of organization non-functional requirements and the library of compliance non-functional requirements into a single organization framework comprising a master set of non-functional requirements for the organization;
select a subset of non-functional requirements from the master set of non-functional requirements for one or more project framework, the subset of non-functional requirements pertinent to a particular project in the organization; and
provide the subset of non-functional requirements as a prioritized task list for completing the project.
